(19) United States
(12) Patent Application Publication
(10) Pub. No.: US 2013/0076179 A1
(43) Pub. Date: Mar. 28, 2013

(54) BEARING ASSEMBLY AND MOTOR INCLUDING THE SAME

(71) Applicant: Ta Kyoung LEE, Hwaseong (KR)

(72) Inventor: Ta Kyoung LEE, Hwaseong (KR)

(73) Assignee: SAMSUNG ELECTRO-MECHANICS CO., LTD, Suwon (KR)

(21) Appl. No.: 13/326,538

(22) Filed: Dec. 15, 2011

(30) Foreign Application Priority Data
Sep. 22, 2011 (KR) 10-2011-0095652

(51) Int. Cl. H02K 7/08; F16C 32/06

(52) U.S. Cl. 310/90; 384/107

(57) ABSTRACT

There is provided a bearing assembly including: a sleeve supporting a shaft and including a circulation hole through which oil is circulated; a thrust plate coupled to the shaft and generating dynamic pressure in the oil; and a base cover coupled to the sleeve to thereby close a lower portion of the sleeve, wherein the oil passes through the circulation hole and is then supplemented between the thrust plate and the base cover in order to suppress bubblegeneration due to leakage of the oil filled between the thrust plate and the base cover at the time of rotation of the shaft.

### CROSS-REFERENCE TO RELATED APPLICATIONS

This application claims the priority of Korean Patent Application No. 10-2011-0095652 filed on Sep. 22, 2010, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a motor capable of being used in a hard disk drive (HDD) rotating a recording disk.

2. Description of the Related Art

A hard disk drive (HDD), an information storage device, reads data stored on a disk or writes data to the disk using a read/write head.

The hard disk drive requires a disk driving device capable of driving the disk. As the disk driving device, a spindle motor is used.

In the spindle motor, a fluid dynamic bearing assembly is used. A shaft, a rotating member of the fluid dynamic bearing assembly, and a sleeve, a fixed members thereof, include oil interposed therebetween, such that the shaft is supported by fluid pressure generated in the oil.

The spindle motor as described above requires a predetermined floating force for rotation of the rotating member. In this case, in order to prevent the rotating member from being excessively floated due to the generation of force larger than floating force required for the rotation of the rotating member, a pulling plate is coupled to an area corresponding to a magnet to thereby suppress floating force.

However, in this case, there is a limitation in providing a constant pulling force based on a shaft due to process characteristics thereof. Therefore, a phenomenon in which the rotating member rotates while being eccentric from the fixed member has not been completely solved.

In addition, the pulling plate provided in order to prevent the excessive floating of the rotating member may be separated from a base due to external impact, or the like, thereby causing a fatal problem in motor performance.

Further, the coupling of the pulling plate allows a thickness of the base to be reduced, thereby having an influence on the strength of the base.

Therefore, in the spindle motor used in a recording disk driving device, research into a new shaft system suppressing excessive floating of a rotating member to thereby improve performance and a lifespan of the spindle motor has been urgently demanded.

### SUMMARY OF THE INVENTION

An aspect of the present invention provides a bearing assembly having a new shaft system structure in which negative pressure between a thrust plate and a base cover is prevented to suppress bubble generation, and a rotating member rotates while descending, at the time of rotation of the rotating member, and a motor including the same.

According to an aspect of the present invention, there is provided a bearing assembly including: a sleeve supporting a shaft and including a circulation hole through which oil is circulated; a thrust plate coupled to the shaft and generating dynamic pressure in the oil; and a base cover coupled to the sleeve to thereby close a lower portion of the sleeve, wherein the oil passes through the circulation hole and is then supplemented between the thrust plate and the base cover in order to suppress bubble generation due to leakage of the oil filled between the thrust plate and the base cover at the time of rotation of the shaft.

The dynamic pressure may be generated by a thrust dynamic pressure part formed in at least one of an upper surface of the thrust plate and the sleeve facing the upper surface of the thrust plate.

The shaft may rotate while descending by force directed downwardly in an axial direction by dynamic pressure at the time of rotation thereof.

The thrust plate and the sleeve may be maintained in a state in which they contact each other while the motor is stopped.

The circulation hole may allow upper and lower surfaces of the sleeve to be in communication with each other and be formed at an outer side of the thrust plate in a radial direction.

The shaft and the thrust plate may be formed integrally with each other.

According to another aspect of the present invention, there is provided a motor including: the bearing assembly as described above; a hub rotating together with the shaft and having a magnet coupled thereto; and a based coupled to the sleeve and including a core having a coil wound therearound, the coil generating rotational driving force.

The thrust plate may be maintained in a state in which it contacts the sleeve by magnetic attractive force due to a difference in position between the magnetic center of the magnet and the center of the core while the motor is stopped.

An oil sealing part allowing an oil interface to be formed may be provided between the upper surface of the sleeve and the hub.

A pumping part pumping the oil between the shaft and the sleeve may be provided in at least one of the upper surface of the sleeve and one surface of the hub facing the upper surface of the sleeve.

An interval between the upper surface of the sleeve and the hub may increase in an outer diameter direction.

The upper surface of the sleeve may be inclined downwardly in an outer diameter direction.

One surface of the hub facing the upper surface of the sleeve maybe inclined upwardly in an outer diameter direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a bearing assembly according to an embodiment of the present invention;

FIG. 2 is a schematic cut-away perspective view showing a sleeve provided in the bearing assembly according to the embodiment of the present invention;

FIG. 3 is a schematic cut-away perspective view showing a hub provided in the bearing assembly according to the embodiment of the present invention;

FIG. 4 is a schematic cross-sectional view showing a stop state of the motor according to the embodiment of the present invention; and

FIGS. 5A and 5B are schematic enlarged cross-sectional views of part A of FIG. 4, showing a stop state and an initial rotation state of the motor according to the embodiment of the present invention, respectively.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

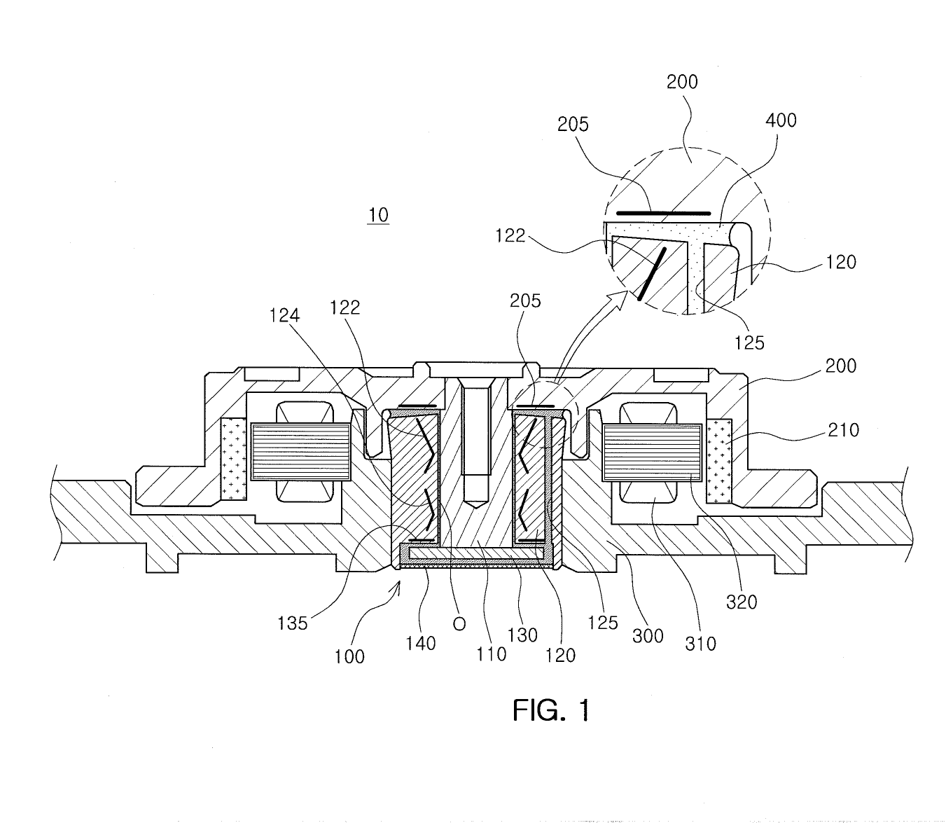

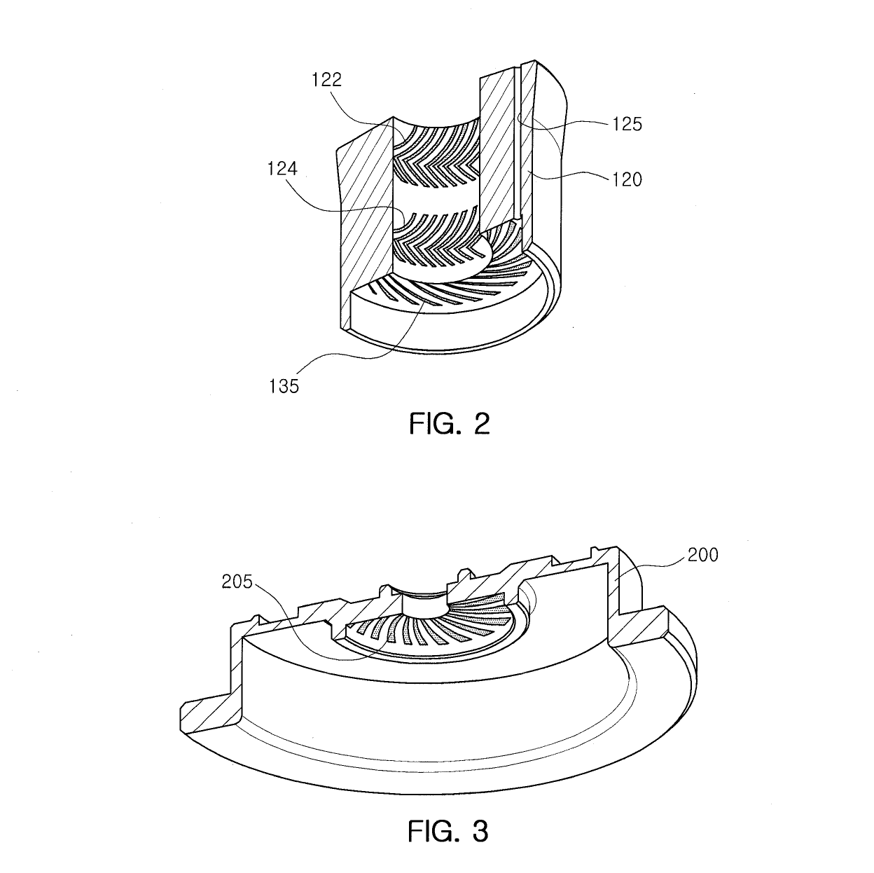

FIG. 1 is a schematic cross-sectional view showing a motor including a bearing assembly according to an embodiment of the present invention; FIG. 2 is a schematic cut-away perspective view showing a sleeve provided in the bearing assembly according to the embodiment of the present invention; and FIG. 3 is a schematic cut-away perspective view showing a hub provided in the bearing assembly according to the embodiment of the present invention.

Referring to FIGS. 1 through 3, a motor 10 according to an embodiment of the present invention may include a bearing assembly 100, a hub 200 having a magnet 210 coupled thereto, and a base 300 including a core 320 having a coil 310 wound therearound.

Terms with respect to directions will be first defined. As viewed in FIG. 1, an axial direction refers to a vertical direction based on the shaft 110, and an outer diameter or inner diameter direction refers to a direction towards an outer edge of the hub 210 based on the shaft 110 or a direction towards the center of the shaft 110 based on the outer edge of the hub 210.

The bearing assembly 100 may include the shaft 110, a sleeve 120 including a circulation hole 125, a thrust plate 130, and a base cover 140.

The sleeve 120 may be a component supporting the shaft 110, a component of the rotating member. The sleeve 120 may support the shaft 110 so that an upper end of the shaft 110 protrudes upwardly in an axial direction and may be formed by forging Cu or Al or sintering a Cu-Fe based alloy powder or a SUS based power.

The sleeve 120 may include a shaft hole having the shaft 110 inserted thereinto so as to have a micro clearance therebetween, wherein the micro clearance may be filled with oil O to thereby stably support the shaft 110 by radial dynamic pressure in the oil O.

Here, the radial dynamic pressure by the oil O may be generated by upper and lower fluid dynamic parts 122 and 124 formed as a groove in an inner peripheral surface of the sleeve 120. The upper and lower fluid dynamic parts 122 and 124 may have anyone of a herringbone shape, a spiral shape, and a screw shape.

However, the upper and lower fluid dynamic parts 122 and 124 are not limited to being formed in the inner peripheral surface of the sleeve 120 as described above but may also be formed in an outer peripheral surface of the shaft 110, the rotating member. In addition, the number of upper and lower fluid dynamic parts 124 and 122 is also not limited.

In addition, the sleeve 120 may include a thrust dynamic pressure part 135 formed in a lower surface thereof, wherein the thrust dynamic pressure part 135 pumps the oil O filled in a clearance between the sleeve 120 and a thrust plate 130 to be described below in an inner diameter direction to thereby generate thrust dynamic pressure downwardly in the axial direction in the thrust plate 130, the rotating member.

That is, when power is applied to the coil 310, the thrust plate 130 may pump the oil O filled between the thrust plate 130 and the sleeve 120 in the inner diameter direction by the thrust dynamic pressure part 135 to thereby allow the rotating member including the shaft 110 and the thrust plate 130 to rotate while descending.

Here, the thrust dynamic pressure part 135 may have one of a herringbone shape, a spiral shape, a screw shape, similar to the upper and lower fluid dynamic parts 122 and 124.

However, the thrust dynamic pressure 135 is not limited to being formed in the lower surface of the sleeve 120 but may also be formed in an upper surface of the thrust plate 130, the rotating member.

The thrust plate 130 may be coupled to the shaft 110 by bonding using an adhesive, welding, press-fitting, or the like, and may also be formed integrally with the shaft 110 rather than a separate member from the shaft 110.

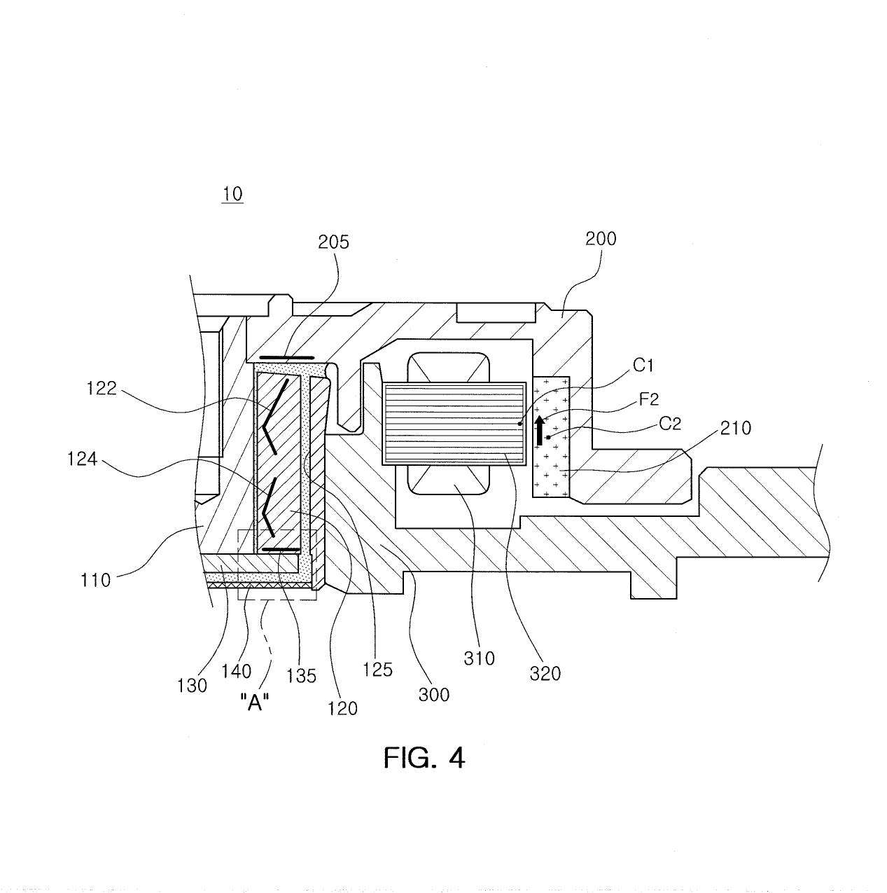

Here, the thrust plate 130 may be maintained in a state in which it contacts the lower surface of the sleeve 120 while the motor is stopped (See FIG. 4), and force allowing the thrust plate 130 to be maintained in a state in which it contacts the lower surface of the sleeve 120 may be generated by a difference in height between the center C1 (See FIG. 4) of the core 320 and the magnetic center C2 (See FIG. 4) of the magnet 210 coupled to the hub 200.

A detailed description thereof will be described below with reference to FIG. 4.

The sleeve 120 may include the base cover 140 coupled thereto at a lower portion thereof in the axial direction, having a clearance therebetween, wherein the clearance receives the oil O therein.

The base cover 140 may receive the oil O in the clearance between the base cover 140 and the sleeve 120 to thereby serve as a bearing supporting a lower surface of the shaft 110.

In addition, the oil O may be continuously filled in a clearance between the shaft 110 and the sleeve 120, in a clearance between a hub 200 to be described below and the sleeve 120, and in clearances between the base cover 140 and the shaft 110 and between the base cover 140 and the thrust plate 130 to thereby form the entire full-fill structure.

Further, an interval between an upper surface of the sleeve 120 and the hub 200 facing the upper surface of the sleeve 120 may increase in the outer diameter direction.

More specifically, as shown in FIG. 1, the upper surface of the sleeve 120 may be inclined downwardly in the outer diameter direction.

In addition, although not shown, one surface of the hub 200 facing the upper surface of the sleeve 120 may be inclined upwardly in the outer diameter direction or both of the upper surface of the sleeve 120 and one surface of the hub 200 may be inclined.

This is to prevent leakage of the oil O using a capillary phenomenon of the oil O filled in the clearance between the upper surface of the sleeve 120 and the hub 200 facing the upper surface of the sleeve 120 to thereby significantly increase the sealing capability of the oil O simultaneously with securing a storage space of the oil O.

An interface of the oil O may be formed between the upper surface of the sleeve 120 and one surface of the hub 200 facing the supper surface of the sleeve 120. In addition, an oil sealing part 400 maintaining the interface of the oil O in a normal state may be provided therebetween.

The oil sealing part 400 may be formed by the upper surface of the sleeve 120 and one surface of the hub 200. More specifically, the oil sealing part 400 refers an interval between the upper surface of the sleeve 120 and one surface of the hub 200.

Here, an interval between the base cover 140 and the thrust plate 130 may be larger than that between the upper surface of the sleeve 120 and the hub 200.

Therefore, when the shaft 110 and the hub 200 moves downwardly in the axial direction due to external impact, or the like, the upper surface of the sleeve 120 and the hub 200 first contact each other to thereby prevent the thrust plate 130 from contacting the base cover 140.

Therefore, since the base cover 140 does not contact the thrust plate 130 in spite of the external impact, or the like, the base cover 140 needs not to have a thickness required to prevent damage due to the contact.

That is, the base cover 140 may be coupled to the sleeve 120 in a state in which it has a thin thickness to thereby seal the lower portion of the sleeve 120.

Therefore, in miniaturization and thinness of the motor 10 according to the embodiment of the present invention, since the thickness of the base cover 140 may be relatively reduced, the entire height of the sleeve 120 may be maintained so as to be equal to that of the sleeve according to the related art or be increased as compared to that of the sleeve according to the related art.

Accordingly, since a distance between points at bent portions in the upper and lower fluid dynamic parts 122 and 124, that is, a bearing span length may be increased, the entire rigidity of the bearing may be improved.

Here, the sleeve 120 may include the circulation hole 125 allowing the upper and lower surfaces thereof to be in communication with each other, wherein the circulation hole 125 may allow internal pressure of the motor 10 according to the embodiment of the present invention to be maintained in an equilibrium state.

In addition, the oil O between the thrust plate 130 and the base cover 140 may be supplemented by the circulation hole 125 when power is applied to the coil 310 and the rotating member including the shaft 110 thus starts to rotate.

In other words, when the rotating member starts to rotate, the oil O filled between the thrust plate 130 and the sleeve 120 may be pumped in the inner diameter direction by the thrust dynamic pressure part 135 formed in at least one of the lower surface of the sleeve 120 and the upper surface of the thrust plate 130.

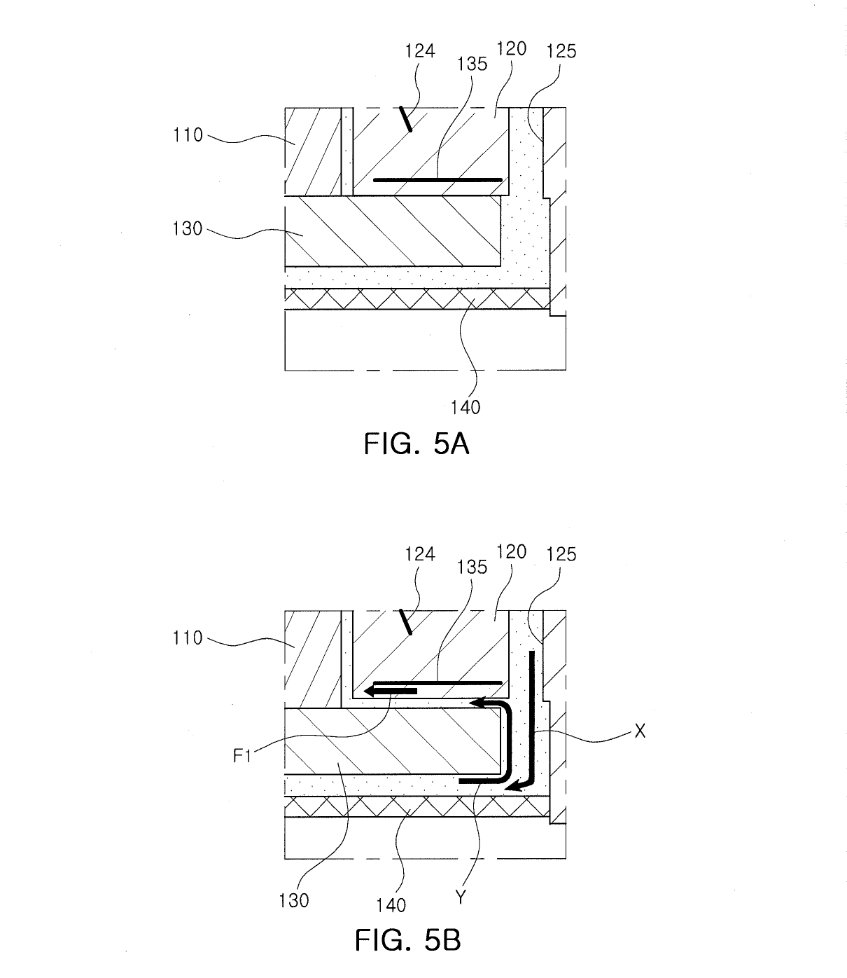

Since this pumping force F1 (See FIG. 5) is in inverse proportion to an interval between the lower surface of the sleeve 120 and the upper surface of the thrust plate 130, relatively strongest pumping force F1 may be generated at the time of initial driving of the motor 10 according to the embodiment of the present invention.

Therefore, at the time of the initial driving of the motor 10 according to the embodiment of the present invention, the oil O filled between the thrust plate 130 and the base cover 140 may be leaked to the outside by the strong pumping force F1 in the inner diameter direction.

Therefore, negative pressure may be generated between the thrust plate 130 and the base cover 140. As a result, bubbles may be generated due to the generation of the negative pressure to thereby cause a defect in smooth rotation of the rotating member including the shaft 110 and the thrust plate 130.

However, since the motor 10 according to the embodiment of the present invention may supplement the oil O between the thrust plate 130 and the base cover 140 by the circulation hole 135 formed at an outer side of the thrust plate 130 in a radial direction, the generation of the bubbles due to the negative pressure at the time of the initial driving of the motor 10 may be prevented in advance.

The hub 200, which is a rotating member coupled to an upper portion of the shaft 110 to thereby rotate together with the shaft 110, may include an annular ring shaped magnet 210 provided on an inner peripheral surface thereof, wherein the annular ring shaped magnet 210 faces the core 320 having the coil 310 wound therearound, having a predetermined interval therebetween.

In addition, the hub 200 may include a pumping part 205 formed in an inner surface thereof, that is, one surface thereof facing the upper surface of the sleeve 120.

The pumping part 205, a component for preventing the leakage of the oil O filled between the upper surface of the sleeve 120 and the hub 200, may pump the oil O between the shaft 110 and the sleeve 120 at the time of the rotation of the motor 10 according to the embodiment of the present invention.

Therefore, the leakage of the oil O due to the external impact, or the like, at the time of the rotation of the motor 10 according to the embodiment of the present invention may be prevented, such that an amount of the oil O may be appropriately maintained. As a result, the dynamic pressure in the oil O is maintained, whereby rigidity of the bearing may be improved.

Here, the pumping part 205 may have a groove having a spiral shape as shown in FIG. 3 but is not limited thereto. That is, the pumping part 205 may also have a herringbone shape or a screw shape.

The base 300, a component coupled to the sleeve 120 to thereby support the rotation of the rotating member, may include the core 320 coupled thereto, wherein the core 320 includes the coil 310 wound therearound.

In other words, the base 300 may be the fixed member including an insertion hole formed therein so that the sleeve 120 supporting the shaft 110, a shaft system of the motor 10 according to the embodiment of the present invention, is coupled thereto, and include the core 320 coupled thereto, wherein the core 320 includes the coil 310 wound theraround and the coil 310 generates electromagnetic force having a predetermined magnitude at the time of application of power.

Therefore, when the power is applied to the coil 310, rotational driving force may be generated by electromagnetic interaction between the coil 310 and the magnet 210.

Here, the base 300 maybe coupled to the sleeve 120 and the core 320 by any one bonding method among an adhesive, a welding method, and a press-fitting method.

FIG. 4 is a schematic cross-sectional view showing a stop state of the motor according to the embodiment of the present invention.

Referring to FIG. 4, while the motor 10 according to the embodiment of the present invention is stopped, the upper surface of the thrust plate 130, which is the rotating member, and the lower surface of the sleeve 120, which is fixed member, may be maintained in a state in which they contact each other.

Here, the force allowing the thrust plate 130 and the sleeve 120 to be maintained in a state in which they contact each other may be generated by a difference in height between the center C1 of the core 320 coupled to the base 300 and the magnetic center C2 of the magnet 210 coupled to the hub 200.

That is, the center C2 of the magnet 210 may be disposed at a position lower than that of the center C1 of the core 320, such that force F2 directed upwardly in the axial direction may always be generated at the time of the driving or the stop of the motor 10 according to the embodiment of the present invention. The force F2 may be larger than the weight of the rotating member.

Here, the weight of the rotating member may be a concept including all of rotating components such as the shaft 110, the thrust plate 130, the hub 200, a disk (not shown), a clamp (not shown) for fixing the disk (not shown), and the like, and a magnitude of magnetic attractive force between the core 320 and the magnet 210 may be in proportion to a distance between the center C1 of the core 320 and the center C2 of the magnet 210.

Therefore, at the time of the stop of the motor 10 according to the embodiment of the present invention, the upper surface of the thrust plate 130 and the lower surface of the sleeve 120 are maintained in a state in which they contact each other, such that a clearance between the upper surface of the sleeve 120 and the lower surface of the hub 200 is larger than a clearance therebetween at the time of the rotation the motor 10.

In addition, the magnetic attractive force due to the difference in height between the center C2 of the magnet 210 and the center C1 of the core 320 may continuously act even in the case in which the motor 10 according to the embodiment of the present invention rotates, and the force F2 of the hub 200 directed upwardly in the axial direction due to the magnetic attractive force may prevent the rotating member from excessively descending.

In the motor included in the hard disk drive, the rotating member generally rotates while being floated upwardly in the axial direction. In this case, in order to prevent the excessive floating of the rotating member, a pulling plate, which is a separate member, is coupled to the base.

This pulling plate is formed as a separate member, thereby causing an increase in cost of the motor. In addition, in the case in which the pulling plate is coupled to the base, a coupling part needs to be formed in the base, thereby having a negative influence on rigidity of the base.

However, the motor 10 according to the embodiment of the present invention has a structure in which the rotating member including the shaft 110 rotates while descending rather than being floated, and does not require a separate member such as the pulling plate for preventing the rotating member from rotating while excessively descending.

That is, the excessive descent problem of the rotating member is solved only by the positions of the center C1 of the core 320 and the magnetic center C2 of the magnet 210, whereby an excellent effect may be generated in view of a manufacturing cost and the rigidity of the base 300.

FIGS. 5A and 5B are schematic enlarged cross-sectional views of part A of FIG. 4, showing a stop state and an initial rotation state of the motor according to the embodiment of the present invention, respectively.

Referring to FIG. 5A, when the motor 10 according to the embodiment of the present invention stops, the magnetic center C2 of the magnet 210 is disposed at a position lower than that of the center C1 of the core 320 in the axial direction, such that the upper surface of the thrust plate 130 and the lower surface of the sleeve 120 are maintained in a state in which they contact each other by the magnetic attractive force acting between the magnet 210 and the core 320, as described above with reference to FIG. 4.

In addition, a clearance between the upper surface of the sleeve 120 and the lower surface of the hub 200 is larger than a clearance therebetween at the time of the rotation the motor.

Referring to FIG. 5B, in the motor 10 according to the embodiment of the present invention, when power is applied from the outside to the coil 310 in order to rotate the rotating member including the shaft 110 and the thrust plate 130, the hub 200 rotates by electromagnetic interaction between the coil 310 and the magnet 210, such that the shaft 110 and the thrust plate 130 that are coupled to the hub 200 also rotate.

Here, a principle that the rotating member of the motor 10 according to the embodiment of the present invention rotates while descending will be described in detail. The force directed downwardly in the axial direction is applied to the thrust plate 130 while the radial dynamic pressure is applied to the shaft 110 by the upper and lower fluid dynamic parts 122 and 124 formed in at least one of the shaft 110 and the sleeve 120.

In addition, the thrust dynamic pressure part 135 generates the pumping force F1 in the inner diameter direction through the oil O filled between the thrust plate 130 and the sleeve 120, such that the thrust dynamic pressure directed downwardly in the axial direction is generated in the thrust plate 130.

Therefore, the thrust plate 130 rotates in a state in which the upper surface thereof is spaced apart from the lower surface of the sleeve 120. As a result, the rotating member may rotate while descending.

When the rotating member rotates, the upper plate of the thrust plate 130 and the lower surface of the sleeve 120 is released from a state in which they contact each other to thereby form a clearance, and the oil O filled in the clearance may be pumped in the inner diameter direction by the thrust dynamic pressure part 135, as described above.

The strongest pumping force F1 is generated at the time of initial driving of the motor 10 according to the embodiment of the present invention. The reason is that the pumping force F1 is in reverse proportion to the interval between the lower surface of the sleeve 120 and the upper surface of the thrust plate 130.

Therefore, at the time of the initial driving of the motor 10 according to the embodiment of the present invention, the oil O filled between the thrust plate 130 and the base cover 140 may be leaked Y to the clearance between the shaft 110 and the sleeve 120 by the strong pumping force F1 in the inner diameter direction.

Due to the strong pumping force F1 as described above, the negative pressure is generated between the thrust plate 130 and the base cover 140, such that the bubbles may be generated to thereby cause a problem in smooth rotation of the rotating member including the thrust plate 130.

However, since the motor 10 according to the embodiment of the present invention may supplement X the oil O between the thrust plate 130 and the base cover 140 by the circulation hole 125 formed at the outer side of the thrust plate 130 in the radial direction at the time of the initial rotation of the rotating member, the generation of the negative pressure at the time of the initial driving of the motor 10 may be prevented in advance.

Therefore, the motor 10 according to the embodiment of the present invention may stably rotate without generation of the bubbles due to the negative pressure at the time of the initial driving thereof.

Thereafter, the rotating member including the shaft 110 and the thrust plate 130 rotates in a state in which it is maintained at a stable descending height. The excessive descent problem of the rotating member may be solved by the position relationship between the center C1 of the core 320 and the center C2 of the magnet 210, that is, a structure in which the center C2 of the magnet 210 is disposed at a position lower than that of the center C1 of the core 320 as described above.

In addition, since the center C2 of the magnet 210 is disposed at the position lower than that of the center C1 of the core 320, the force F2 directed upwardly in the axial direction acts on the entire magnet 210, whereby the fixed member including the base 300 may more stably support the rotating member.

Therefore, a phenomenon in which the rotating member rotates while being eccentric from the center of the shaft is prevented, whereby the motor 10 may be stably driven.

Through the above-mentioned embodiments, the bearing assembly 100 and the motor 10 including the same according to the present invention prevents the negative pressure between the thrust plate 130 and the base cover 140 by allowing the oil O to be introduced through the circulation hole 125 at the time of the rotation of the rotating member, whereby the generation of the bubbles may be suppressed.

As set forth above, in a bearing assembly and a motor including the same according to embodiments of the present invention, a phenomenon in which the rotating member rotates while excessively descending maybe prevented without using a separate member and a phenomenon in which the rotating member rotates while being eccentric from the center of the shaft may be prevented.

Further, the rigidity of the bearing may be improved due to an increase in bearing span length, whereby rotational characteristics may be significantly increased.

Furthermore, the negative pressure between the thrust plate and the base cover at the time of the rotation of the rotating member may be prevented to suppress the generation of the bubbles, whereby performance and a lifespan of the motor may be significantly incrased.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft and including a circulation hole having oil circulated therein;
a thrust plate coupled to the shaft and generating dynamic pressure in the oil; and
a base cover coupled to the sleeve to thereby close a lower portion of the sleeve,
the oil passing through the circulation hole to then be supplemented between the thrust plate and the base cover in order to suppress bubble generation due to leakage of the oil filled between the thrust plate and the base cover at the time of rotation of the shaft.

2. The bearing assembly of claim 1, wherein dynamic pressure is generated by a thrust dynamic pressure part formed in at least one of an upper surface of the thrust plate and the sleeve facing the upper surface of the thrust plate.

3. The bearing assembly of claim 1, wherein the shaft rotates while descending by force directed downwardly in an axial direction by dynamic pressure at the time of rotation thereof.

4. The bearing assembly of claim 1, wherein the thrust plate and the sleeve are maintained in a state in which they contact each other while the motor is stopped.

5. The bearing assembly of claim 1, wherein the circulation hole allows upper and lower surfaces of the sleeve to be in communication with each other and is formed at an outer side of the thrust plate in a radial direction.

6. The bearing assembly of claim 1, wherein the shaft and the thrust plate are formed integrally with each other.

7. A motor comprising:
the bearing assembly of claim 1;
a hub rotating together with the shaft and having a magnet coupled thereto; and
a base coupled to the sleeve and including a core having a coil wound therearound, the coil generating rotational driving force.

8. The motor of claim 7, wherein the thrust plate is maintained in a state in which it contacts the sleeve by magnetic attractive force due to a difference in position between the magnetic center of the magnet and the center of the core while the motor is stopped.

9. The motor of claim 7, wherein the sleeve and the hub include an oil sealing part between the upper surface of the sleeve and the hub, the oil sealing part allowing an oil interface to be formed therein.

10. The motor of claim 7, wherein the shaft and the sleeve include a pumping part pumping the oil therebetween in at least one of the upper surface of the sleeve and one surface of the hub facing the upper surface of the sleeve.

11. The motor of claim 7, wherein an interval between the upper surface of the sleeve and the hub increases in an outer diameter direction.

12. The motor of claim 7, wherein the upper surface of the sleeve is inclined downwardly in an outer diameter direction.

13. The motor of claim 7, wherein one surface of the hub facing the upper surface of the sleeve is inclined upwardly in an outer diameter direction.
